(19) United States
(12) Patent Application Publication
(10) Pub. No.: US 2024/0001343 A1
(43) Pub. Date: Jan. 4, 2024

(54) PLATINUM ENRICHED MULTI-REGION CATALYSTS FOR CNG ENGINE EXHAUST GAS TREATMENTS

(71) Applicant: JOHNSON MATTHEY (SHANGHAI) CHEMICALS LIMITED, Shanghai (CN)

(72) Inventors: Dongsheng QIAO, Shanghai (CN); Jingwen WANG, Shanghai (CN)

(21) Appl. No.: 18/335,183

(22) Filed: Jun. 15, 2023

Related U.S. Application Data
(60) Provisional application No. 63/368,211, filed on Jul. 12, 2022.

(30) Foreign Application Priority Data
Jun. 30, 2022 (CN) 202210785377.7

(51) Int. Cl. B01J 23/46; B01J 23/42; B01J 23/44; B01J 23/10; B01J 23/02; B01J 35/00; B01J 35/04; B01D 53/94; F01N 3/10

(52) U.S. Cl. CPC B01J 23/464; B01J 23/42; B01J 23/44; B01J 23/10; B01J 23/02; B01J 35/0006; B01J 35/04; B01D 53/945; B01D 53/9454; B01D 53/9468; B01D 53/9472; F01N 3/101; B01D 2255/1021; B01D 2255/1023; B01D 2255/1025; B01D 2255/40; B01D 2255/908; B01D 2255/9022; B01D 2255/9025; B01D 2255/9032; B01D 2255/904

(57) ABSTRACT

A three-way catalyst article, and its use in an exhaust system for compressed natural gas engines, is disclosed. The catalyst article for treating exhaust gas from compressed natural gas (CNG) engine comprising: a substrate comprising an inlet end, an outlet end with an axial length L; a first catalytic region beginning at the inlet end and extending for less than the axial length L, wherein the first catalytic region comprises a first platinum component; a second catalytic region beginning at the outlet end and extending for less than the axial length L, wherein the second catalytic region comprises a second palladium component; and a third catalytic region, wherein the third catalytic region comprises a third rhodium component.

### FIELD OF THE INVENTION

The present invention relates to catalyzed articles useful in treating exhaust gas emissions from compressed natural gas (CNG) engines.

### BACKGROUND OF THE INVENTION

Compressed natural gas (CNG) is composed of simple hydrocarbons, primarily methane, which leads to much lower CO₂ generation produced per unit of energy, and CNG has been used as one clean energy alternative to the conventional gasoline and diesel fuel.

Besides this, CNG is also preferred in the market due to its abundance in the supply and the relatively lower price, therefore in recent years, CNG engines have attracted increasing attention in the auto market, especially for the heavy-duty vehicle which operating with a CNG engine operating under the stoichiometric calibration. Even operating under CNG, automotive exhaust emission is inevitable, which usually consists of the typical pollutants like hydrocarbons (HCs), carbon monoxide (CO) and nitrogen oxides (“NOₓ”), and the traditional gasoline emission catalyst, three-way catalysts (TWC) are usually applied for the exhaust emissions control from the CNG engine.

Palladium (Pd) and rhodium (Rh) have been widely used in TWC formulations to reduce harmful emissions in gasoline vehicles. The similar Pd—Rh TWC is usually used in stoichiometric CNG engine application, where usually containing relatively high Pd loading. However, in recent years, these precious metal prices have climbed up to be even more precious, due to rising demand in the market. On the other hand, tighter environmental regulations worldwide have forced automobile industries to put even more precious metals into their catalytic converters. In the meantime, platinum (Pt) has become a more attractive candidate for gasoline applications due to its relatively cheaper price, and today the price of Pd is still almost twice higher of Pt's price, Thus, there are huge financial incentives on how to introduce Pt into catalyst formulations, or at least partially replace Pd while hoping to maintain comparable catalyst performances. In the past, when simply replacing Pd with Pt on current existing Pd—Rh TWC formulations, inferior performance was typically observed, especially when increasing replacement ratio.

In order to meet the increasingly stringent legislation and achieve cost saving, as a result, Pt utilization in CNG application has drawn broadly attention in the market. This work brings a new approach in the catalyst design, this novel Pt enriched TWC design not only shows improved emission control performance, but also provides a significant cost reduction through optimization of Pt and Pd location in multi catalytic regions as described in this invention.

### SUMMARY OF THE INVENTION

One aspect of the present disclosure is directed to a catalyst article for treating exhaust gas from compressed natural gas (CNG) engine comprising: a substrate comprising an inlet end, an outlet end with an axial length L; a first catalytic region beginning at the inlet end and extending for less than the axial length L, wherein the first catalytic region comprises a first platinum component; a second catalytic region beginning at the outlet end and extending for less than the axial length L, wherein the second catalytic region comprises a second palladium component; and a third catalytic region, wherein the third catalytic region comprises a third rhodium component.

The invention also encompasses an exhaust system for the CNG engines that comprises the catalyst article of the invention.

The invention also encompasses treating an exhaust gas from a CNG engine, in particular for treating exhaust gas from a stoichiometric CNG engine. The method comprises contacting the exhaust gas with the catalyst article of the invention.

### BRIEF DESCRIPTION OF THE DRAWINGS

FIG. 1a shows one embodiment according to the present invention, the first catalytic region extends less than 100% of the axial length L, from the inlet end; the second catalytic region extends for less than 100% of the axial length L, form the outlet end. The total length of the second and the first catalytic region is equal to the axial length L. The 3^{rd} catalytic region extends 100% of the axial length L and overlies the first and second catalytic regions as top layer.

FIG. 1b shows one embodiment according to the present invention, the first catalytic region extends less than 100% of the axial length L, from the inlet end; the second catalytic region extends for less than 100% of the axial length L, form the outlet end. The total length of the second and the first catalytic region is greater than the axial length L. The 3^{rd} catalytic region extends 100% of the axial length L and overlies the first and second catalytic regions as top layer.

FIG. 1c depicts a variation of FIG. 1b.

FIG. 1d shows one embodiment according to the present invention, the first catalytic region extends less than 100% of the axial length L, from the inlet end; the second catalytic region extends for less than 100% of the axial length L, form the outlet end. The total length of the second and the first catalytic region is less than the axial length L. The 3^{rd} catalytic region extends 100% of the axial length L and overlies the first and second catalytic regions as top layer.

FIG. 1e shows one embodiment according to the present invention, the 3^{rd} catalytic region extends 100% of the axial length L as the bottom layer, the first catalytic region extends less than 100% of the axial length L, from the inlet end; the second catalytic region extends for less than 100% of the axial length L, form the outlet end. The total length of the second and the first catalytic region is equal to (can also be greater than or less than) the axial length L.

FIG. 2a shows one embodiment according to the present invention, the first catalytic region extends less than 100% of the axial length L, from the inlet end; the second catalytic region extends for less than 100% of the axial length L, form the outlet end. The total length of the second and the first catalytic region is equal to (can also be greater than or less than) the axial length L. The 3^{rd} catalytic region extends less than 100% of the axial length L from the inlet end.

FIG. 2b shows one embodiment according to the present invention, the first catalytic region extends less than 100% of the axial length L, from the inlet end; the second catalytic region extends for less than 100% of the axial length L, form the outlet end. The total length of the second and the first catalytic region is equal to (can also be greater than or less than) the axial length L. The 3^{rd} catalytic region extends less than 100% of the axial length L from the outlet end.

### DETAILED DESCRIPTION OF THE INVENTION

The present invention is directed to catalytic treatment of combustion exhaust gas, such as that produced by stoichiometric CNG engines, and to related catalytic articles and systems. More specifically, the invention relates to Pt containing TWC, which improves emission control performance on CH₄ and NOₓ in a vehicular exhaust system and the present invention also reduces the cost of the catalyst through Pd substitution with Pt.

One aspect of the present disclosure is directed to a catalyst article for treating exhaust gas from compressed natural gas (CNG) engine comprising: a substrate comprising an inlet end, an outlet end with an axial length L; a first catalytic region beginning at the inlet end and extending for less than the axial length L, wherein the first catalytic region comprises a first platinum component; a second catalytic region beginning at the outlet end and extending for less than the axial length L, wherein the second catalytic region comprises a second palladium component; and a third catalytic region, wherein the third catalytic region comprises a third rhodium component.

### First Catalytic Region

The first catalytic region can comprise 0.1-300 g/ft³ of the first Pt component. Preferably, the first catalytic region can comprise 10-200 g/ft³ of the first Pt component, more preferably, 15-150 g/ft³ of the first Pt component. In some embodiments, the first catalytic region can further comprise a first Pd component, wherein the weight ratio of Pd in the first catalytic region to Pt in the first catalytic region can be less than 1:1; preferably less than 1:2; more preferably no more than 1:3, 1:5, 1:8, 1:10, or 1:20.

Alternatively, the first catalytic region can be essentially free of other PGM component other than the first Pt component.

The first catalytic region can further comprise a first oxygen storage capacity (OSC) material, a first alkali or alkaline earth metal component, and/or a first inorganic oxide.

The first OSC material can be cerium oxide, zirconium oxide, a ceria-zirconia mixed oxide, an alumina-ceria-zirconia mixed oxide, or a combination thereof. More preferably, the first OSC material comprises the ceria-zirconia mixed oxide, the alumina-ceria-zirconia mixed oxide or a combination thereof. The ceria-zirconia mixed oxide can further comprise dopants, such as lanthanum, neodymium, praseodymium, yttrium oxides, etc. The first OSC material may function as a support material for the first Pt component. In some embodiments, the first OSC material comprises the ceria-zirconia mixed oxide and the alumina-ceria-zirconia mixed oxide.

The first inorganic oxide is preferably an oxide of Groups 2, 3, 4, 5, 13 and 14 elements. The first inorganic oxide is preferably selected from the group consisting of alumina, zirconia, magnesia, silica, lanthanum, neodymium, praseodymium, yttrium oxides, and mixed oxides or composite oxides thereof. Particularly preferably, the first inorganic oxide is alumina, lanthanum-alumina, zirconia, or a magnesia/alumina composite oxide. Even more preferably, the first inorganic oxide is alumina, a lanthanum/alumina composite oxide, or a magnesia/alumina composite oxide. One especially preferred first inorganic oxide is alumina or lanthanum-alumina.

The first OSC material and the first inorganic oxide can have a weight ratio of no greater than 10:1, preferably, no greater than 8:1 or 5:1, more preferably, no greater than 4:1, most preferably, no greater than 3:1.

Alternatively, the first OSC material and the first inorganic oxide can have a weight ratio of 10:1 to 1:10, preferably, 8:1 to 1:8; more preferably, 5:1 to 1:5; and most preferably, 4:1 to 1:4.

The first OSC material loading in the second catalytic region can be less than 2 g/in³. In some embodiments, the first OSC material loading in the first catalytic region is no greater than 1.5 g/in³, 1.2 g/in³, 1 g/in³, 0.8 g/in³, or 0.7 g/in³.

The first alkali or alkaline earth metal is preferably barium, or strontium, and mixed oxides or composite oxides thereof. Preferably the barium or strontium, where present, is loaded in an amount of 0.1 to 15 wt. %, and more preferably 1.5 to 10 wt. % of barium or strontium, based on the total weight of the first catalytic region.

Preferably the barium or the strontium is present as BaCO₃ or SrCO₃. Such a material can be performed by any method known in the art, for example incipient wetness impregnation or spray-drying.

In some embodiments, the first catalytic region is substantially free of the first alkali or alkaline earth metal. In further embodiments, the first catalytic region is substantially free of, or does not comprise, the first alkali or alkaline earth metal.

In some embodiments, the first catalytic region can extend for 10% to 90%, 20% to 80%, or 30% to 70% of the axial length L. Alternatively, the first catalytic region can extend for 35% to 65% of the axial length L. Preferably, for 40% to 65%, more preferably, 45% to 65% percent of the axial length L.

Alternatively, the first catalytic region can be no greater than 99%, 95%, 90%, or 85% of the axial length L. Alternatively, in certain embodiments, the first catalytic region can be no greater than 50%, 40%, 30%, or 20% of the axial length L

The first catalytic region may further comprise a first rare earth metal component, such as lanthanum, neodymium, praseodymium, yttrium, Gadolinium, Scandium etc., or mixture thereof. These rare earth metal components can be introduced as dopants, or mixed in as physical mixture/blend, such as in oxide forms.

The total washcoat loading of the first catalytic region can be less than 3.5 g/in³, preferably, less than 3.0 g/in³ or 2.5 g/in³. Alternatively, the total washcoat loading of the first catalytic region can be from 0.5 to 3.5 g/in³; preferably, can be from 0.6 to 3 g/in³ or 0.7 to 2.5 g/in³.

### Second Catalytic Region

The second catalytic region can comprise 0.1-150 g/ft³ of the second Pd component. Preferably, the second catalytic region can comprise 5-120 g/ft³ of the second Pd component, more preferably, 10-90 g/ft³ of the second Pd component. In some embodiments, the second catalytic region can fourth comprise a second Pt component, wherein the weight ratio of Pt in the second catalytic region to Pd in the second catalytic region can be less than 1:1; preferably, less than 1:2; more preferably, no more than 1:3, 1:5, 1:8, 1:10, or 1:20.

Alternatively, in certain embodiments, the weight ratio of Pd in the second catalytic region to Pt in the second catalytic region can be less than 1:1; preferably less than 1:2; more preferably at least 1:3, 1:5, 1:8, 1:10, or 1:20.

Alternatively, the second catalytic region can be essentially free of other PGM component other than the second Pd component.

The second catalytic region can further comprise a second oxygen storage capacity (OSC) material, a second alkali or alkaline earth metal component, and/or a second inorganic oxide.

The second OSC material can be cerium oxide, zirconium oxide, a ceria-zirconia mixed oxide, an alumina-ceria-zirconia mixed oxide, or a combination thereof. More preferably, the second OSC material comprises the ceria-zirconia mixed oxide, the alumina-ceria-zirconia mixed oxide, or a combination thereof. In addition, the second OSC material may further comprise one or more of dopants like lanthanum, neodymium, praseodymium, yttrium etc. Moreover, the second OSC material may have the function as a support material for the second Pd and/r Pt component. In some embodiments, the second OSC material comprises the ceria-zirconia mixed oxide and the alumina-ceria-zirconia mixed oxide.

The ceria-zirconia mixed oxide can have a weight ratio of zirconia dioxide to ceria dioxide at least 50:50, preferably, higher than 60:40, more preferably, higher than 65:35. Alternatively, the ceria-zirconia mixed oxide also can have a weight ratio of ceria dioxide to zirconia dioxide less than 50:50, preferably, less than 40:60, more preferably, less than 35:65.

The second OSC material (e.g., ceria-zirconia mixed oxide) can be from 10 to 90 wt. %, preferably, 20-90 wt. %, more preferably, 30-90 wt. %, based on the total washcoat loading of the second catalytic region.

The second OSC material loading in the second catalytic region can be less than 2 g/in³. In some embodiments, the second OSC material loading in the second catalytic region is no greater than 1.5 g/in³, 1.2 g/in³, 1 g/in³, 0.8 g/in³, or 0.7 g/in³.

The second alkali or alkaline earth metal is preferably barium, strontium, mixed oxides or composite oxides thereof. Preferably the barium or strontium, where present, is in an amount of 0.1 to 15 wt. %, and more preferably 1.5 to 10 wt. % of barium or strontium, based on the total weight of the second catalytic region.

It is even more preferable that the second alkali or alkaline earth metal is strontium. The strontium, where present, is preferably present in an amount of 0.1 to 15 wt. %, and more preferably 1.5 to 10 wt. %, based on the total weight of the second catalytic region.

It is also preferable that the second alkali or alkaline earth metal is mixed oxides or composite oxide of barium and strontium. Preferably, the mixed oxides or composite oxide of barium and strontium is present in an amount of 0.1 to 15 wt. %, and more preferably 1.5 to 10 wt. %, based on the total weight of the second catalytic region. It is more preferable that the second alkali or alkaline earth metal is composite oxide of barium and strontium.

Preferably the barium or strontium is present as BaCO₃ or SrCO₃. Such a material can be performed by any method known in the art, for example incipient wetness impregnation or spray-drying.

In some embodiments, the second catalytic region is substantially free of the second alkali or alkaline earth metal. In further embodiments, the second catalytic region is substantially free of, or does not comprise, the second alkali or alkaline earth metal.

The second inorganic oxide is preferably an oxide of Groups 2, 3, 4, 5, 13 and 14 elements. The second inorganic oxide is preferably selected from the group consisting of alumina, zirconia, magnesia, silica, lanthanum, yttrium, neodymium, praseodymium oxides, and mixed oxides or composite oxides thereof. Particularly preferably, the second inorganic oxide is alumina, lanthanum-alumina, zirconia, or a magnesia/alumina composite oxide. One especially preferred second inorganic oxide is alumina or lanthanum-alumina.

The second OSC material and the second inorganic oxide can have a weight ratio of no greater than 10:1, preferably, no greater than 8:1, more preferably, no greater than 5:1, most preferably, no greater than 4:1.

Alternatively, the second OSC material and the second inorganic oxide can have a weight ratio of 10:1 to 1:10, preferably, 8:1 to 1:8; more preferably, 5:1 to 1:5; and most preferably, 4:1 to 1:4.

In some embodiments, the second catalytic region can extend for 10% to 90%, 20% to 80%, or 30% to 70% of the axial length L. Alternatively, the second catalytic region can extend for 35% to 65% of the axial length L. Preferably, for 40% to 65%, more preferably, 45% to 65% percent of the axial length L.

Alternatively, the second catalytic region can be no greater than 99%, 95%, 90%, or 85% of the axial length L.

Preferably, the total length of the second region and the first region is equal or greater than the axial length L.

The second catalytic region can overlap with the first catalytic region for 1 to 80 percent; preferably, 1 to 60 percent; more preferably 1-50 percent, 1-30 percent, 1-20 percent, or even 1-15 percent of the axial length L. Alternatively, the total length of the second catalytic region and the first catalytic region can equal to the axial length L. In yet another alternative, the total length of the second catalytic region and the first catalytic region can be less than the axial length L, for example, no greater than 95%, 90%, 80%, or 70% of the axial length L.

In some embodiments, the first catalytic region can be supported/deposited directly on the substrate. In certain embodiments, the second catalytic region can be supported/deposited directly on the substrate.

The second catalytic region may further comprise a second rare earth metal component, such as lanthanum, neodymium, praseodymium, yttrium, Gadolinium, Scandium etc., or a combination thereof. These rare earth metal components can be introduced as dopants, or mixed in as physical mixture/blend, such as in oxide forms.

The total washcoat loading of the second catalytic region can be less than 3.5 g/in³, preferably, less than 3.0 g/in³ or 2.5 g/in³. Alternatively, the total washcoat loading of the first catalytic region can be from 0.5 to 3.5 g/in³; preferably, can be from 0.6 to 3 g/in³ or 0.7 to 2.5 g/in³.

### Third Catalytic Region

The third catalytic region can comprise 0.1-30 g/ft³ of the third Rh component. Preferably, the third catalytic region can comprise 0.5-15 g/ft³ of the third Rh component, more preferably, 1-10 g/ft³ of the third Rh component.

The third catalytic region can further comprise a third PGM component, a third oxygen storage capacity (OSC) material, a third alkali or alkaline earth metal component, and/or a third inorganic oxide.

The third PGM component can be platinum, palladium, or a mixture thereof.

Alternatively, the third catalytic region can be essentially free of other PGM component other than the third Rh component.

The third OSC material can be cerium oxide, zirconium oxide, a ceria-zirconia mixed oxide, an alumina-ceria-zirconia mixed oxide, or a combination thereof. More preferably, the third OSC material comprises the ceria-zirconia mixed oxide, the alumina-ceria-zirconia mixed oxide, or a combination thereof. In addition, the third OSC material may further comprise one or more of dopants like lanthanum, neodymium, praseodymium, yttrium etc. Moreover, the third OSC material may have the function as a support material for the third Rh and/or PGM component. In some embodiments, the third OSC material comprises the ceria-zirconia mixed oxide and the alumina-ceria-zirconia mixed oxide.

The ceria-zirconia mixed oxide can have a weight ratio of zirconia dioxide to ceria dioxide at least 50:50, preferably, higher than 60:40, more preferably, higher than 65:35. Alternatively, the ceria-zirconia mixed oxide also can have a weight ratio of ceria dioxide to zirconia dioxide less than 50:50, preferably, less than 40:60, more preferably, less than 35:65.

The third OSC material (e.g., ceria-zirconia mixed oxide) can be from 10 to 90 wt. %, preferably, 25-75 wt. %, more preferably, 30-60 wt. %, based on the total washcoat loading of the third catalytic region.

The third OSC material loading in the third catalytic region can be less than 2 g/in³. In some embodiments, the third OSC material loading in the second catalytic region is no greater than 1.5 g/in³, 1.2 g/in³, 0.9 g/in³, 0.8 g/in³, or 0.7 g/in³.

The total washcoat loading of the third catalytic region can be less than 3.5 g/in³, preferably, no more than 3.0 g/in³, 2.5 g/in³, or 2 g/in³.

The third alkali or alkaline earth metal is preferably barium, strontium, mixed oxides or composite oxides thereof. Preferably the barium or strontium, where present, is in an amount of 0.1 to 15 wt. %, and more preferably 3 to 10 wt. % of barium or strontium, based on the total weight of the third catalytic region.

It is even more preferable that the third alkali or alkaline earth metal is strontium. The strontium, where present, is preferably present in an amount of 0.1 to 15 wt. %, and more preferably 1.5 to 10 wt. %, based on the total weight of the third catalytic region.

It is also preferable that the third alkali or alkaline earth metal is mixed oxides or composite oxide of barium and strontium. Preferably, the mixed oxides or composite oxide of barium and strontium is present in an amount of 0.1 to 15 wt. %, and more preferably 1.5 to 10 wt. %, based on the total weight of the third catalytic region. It is more preferable that the third alkali or alkaline earth metal is composite oxide of barium and strontium.

Preferably the barium or strontium is present as BaCO₃ or SrCO₃. Such a material can be performed by any method known in the art, for example incipient wetness impregnation or spray-drying.

In some embodiments, the third catalytic region is substantially free of the third alkali or alkaline earth metal. In further embodiments, the third catalytic region is substantially free of, or does not comprise, the third alkali or alkaline earth metal.

The third inorganic oxide is preferably an oxide of Groups 2, 3, 4, 5, 13 and 14 elements. The third inorganic oxide is preferably selected from the group consisting of alumina, zirconia, magnesia, silica, lanthanum, neodymium, praseodymium, yttrium oxides, and mixed oxides or composite oxides thereof. Particularly preferably, the third inorganic oxide is alumina, lanthanum-alumina, zirconia, or a magnesia/alumina composite oxide. One especially preferred third inorganic oxide is alumina or lanthanum-alumina.

The third OSC material and the third inorganic oxide can have a weight ratio of no greater than 10:1, preferably, no greater than 8:1 or 5:1, more preferably, no greater than or 5:1, most preferably, no greater than 4:1.

Alternatively, the third OSC material and the third inorganic oxide can have a weight ratio of 10:1 to 1:10, preferably, 8:1 to 1:8 or; more preferably, 5:1 to 1:5 or; and most preferably, 4:1 to 1:4.

The third catalytic region can extend for 100 percent of the axial length L. Alternatively, the third catalytic region can be less than the axial length L, for example, no greater than 95%, 90%, 80%, or 70% of the axial length L. In certain embodiments, the third catalytic region can extend from the inlet end. In other embodiments, the third catalytic region can extend from the outlet end. In some embodiments, the third catalytic region can be supported/deposited directly on the substrate.

In some embodiments, the first Pt component in the first catalytic region can be at least 50%, 60%, 70%, or even 80% of the overall Pt loading in the catalyst article.

In certain embodiments, the ratio of the overall Pt loading to the overall Pd loading (by weight) is at least 1:5, at least 1:4, at least 1:3, at least 2:5, or 1:2.

### Configurations of First, Second, and Third Catalytic Regions

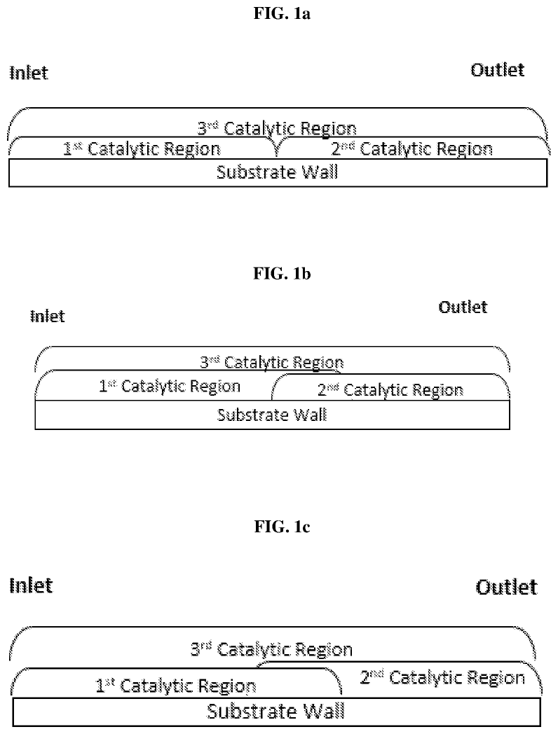

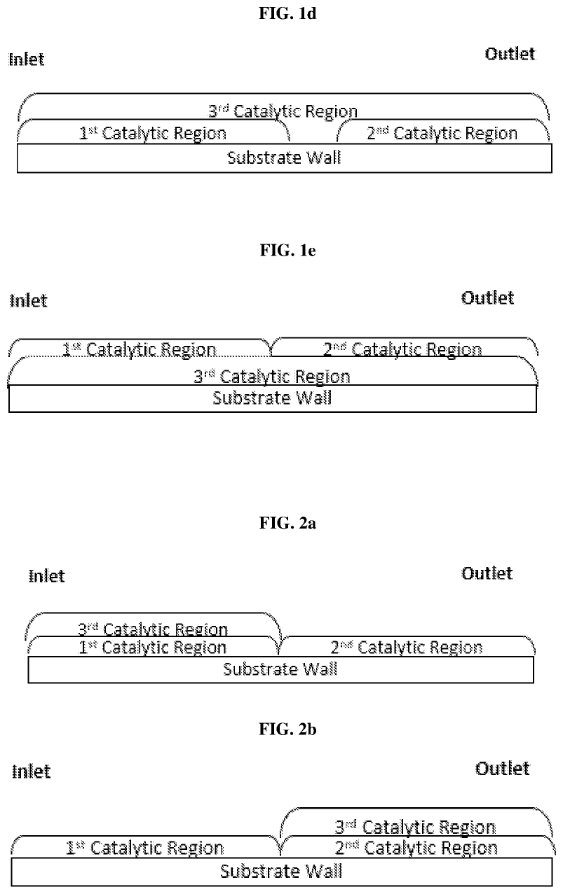

The second catalytic region can overlap with the first catalytic region for 1 to 80 percent; preferably, 1 to 60 percent; more preferably 1-50 percent, 1-30 percent, 1-20 percent, or even 1-15 percent of the axial length L. (e.g., see FIG. 1b, FIG. 1c; the first catalyst region can overlie the second catalytic region, or the second catalyst region can overlie the first catalytic region). Alternatively, the total length of the second catalytic region and the first catalytic region can equal to the axial length L. (e.g., see FIG. 1a, FIG. 2a). In yet another alternative, the total length of the second catalytic region and the first catalytic region can be less than the axial length L, for example, no greater than 95%, 90%, 80%, or 70% of the axial length L (e.g., see FIG. 1d).

In one aspect of the invention, various configurations of catalytic articles comprising the first, second, and third catalytic regions can be prepared as below.

FIG. 1a shows one embodiment according to the present invention, the first catalytic region extends less than 100% of the axial length L, from the inlet end; the second catalytic region extends for less than 100% of the axial length L, form the outlet end. The total length of the second and the first catalytic region is equal to the axial length L. The 3^{rd} catalytic region extends 100% of the axial length L and overlies the first and second catalytic regions as top layer.

FIG. 1b shows one embodiment according to the present invention, the first catalytic region extends less than 100% of the axial length L, from the inlet end; the second catalytic region extends for less than 100% of the axial length L, form the outlet end. The total length of the second and the first catalytic region is greater than the axial length L. The 3^{rd} catalytic region extends 100% of the axial length L and overlies the first and second catalytic regions as top layer.

FIG. 1c depicts a variation of FIG. 1b.

FIG. 1d shows one embodiment according to the present invention, the first catalytic region extends less than 100% of the axial length L, from the inlet end; the second catalytic region extends for less than 100% of the axial length L, form the outlet end. The total length of the second and the first catalytic region is less than the axial length L. The 3^{rd} catalytic region extends 100% of the axial length L and overlies the first and second catalytic regions as top layer.

FIG. 1e shows one embodiment according to the present invention, the 3^{rd} catalytic region extends 100% of the axial length L as the bottom layer, the first catalytic region extends less than 100% of the axial length L, from the inlet end; the second catalytic region extends for less than 100% of the axial length L, form the outlet end. The total length of the second and the first catalytic region is equal to (can also be greater than or less than) the axial length L.

FIG. 2a shows one embodiment according to the present invention, the first catalytic region extends less than 100% of the axial length L, from the inlet end; the second catalytic region extends for less than 100% of the axial length L, form the outlet end. The total length of the second and the first catalytic region is equal to (can also be greater than or less than) the axial length L. The 3^{rd} catalytic region extends less than 100% of the axial length L from the inlet end.

FIG. 2b shows one embodiment according to the present invention, the first catalytic region extends less than 100% of the axial length L, from the inlet end; the second catalytic region extends for less than 100% of the axial length L, form the outlet end. The total length of the second and the first catalytic region is equal to (can also be greater than or less than) the axial length L. The 3^{rd} catalytic region extends less than 100% of the axial length L from the outlet end.

### Substrate

Preferably the substrate is a flow-through monolith.

The substrate can be less than 200 mm in length, preferably from 60 to 160 mm.

The flow-through monolith substrate has a first face and a second face defining a longitudinal direction there between. The flow-through monolith substrate has a plurality of channels extending between the first face and the second face. The plurality of channels extends in the longitudinal direction and provide a plurality of inner surfaces (e.g. the surfaces of the walls defining each channel). Each of the plurality of channels has an opening at the first face and an opening at the second face. For the avoidance of doubt, the flow-through monolith substrate is not a wall flow filter.

The first face is typically at an inlet end of the substrate and the second face is at an outlet end of the substrate.

The channels may be of a constant width and each plurality of channels may have a uniform channel width.

Preferably within a plane orthogonal to the longitudinal direction, the monolith substrate has from 300 to 900 channels per square inch, preferably from 400 to 800. For example, on the first face, the density of open first channels and closed second channels is from 600 to 700 channels per square inch. The channels can have cross sections that are rectangular, square, circular, oval, triangular, hexagonal, or other polygonal shapes.

The monolith substrate acts as a support for holding catalytic material. Suitable materials for forming the monolith substrate include ceramic-like materials such as cordierite, silicon carbide, silicon nitride, zirconia, mullite, spodumene, alumina-silica magnesia or zirconium silicate, or of porous, refractory metal. Such materials and their use in the manufacture of porous monolith substrates are well known in the art.

It should be noted that the flow-through monolith substrate described herein is a single component (i.e. a single brick). Nonetheless, when forming an emission treatment system, the substrate used may be formed by adhering together a plurality of channels or by adhering together a plurality of smaller substrates as described herein. Such techniques are well known in the art, as well as suitable casings and configurations of the emission treatment system.

In embodiments wherein the catalyst article of the present comprises a ceramic substrate, the ceramic substrate may be made of any suitable refractory material, e.g., alumina, silica, ceria, zirconia, magnesia, zeolites, silicon nitride, silicon carbide, zirconium silicates, magnesium silicates, aluminosilicates and metalloid aluminosilicates (such as cordierite and spodumene), or a mixture or mixed oxide of any two or more thereof. Cordierite, a magnesium aluminosilicate, and silicon carbide are particularly preferred.

In embodiments wherein the catalyst article of the present invention comprises a metallic substrate, the metallic substrate may be made of any suitable metal, and in particular heat-resistant metals and metal alloys such as titanium and stainless steel as well as ferritic alloys containing iron, nickel, chromium, and/or aluminum in addition to other trace metals.

Another aspect of the present disclosure is directed to a method for treating a vehicular exhaust gas from CNG engine containing NOₓ, CO, and HC (methane) using the catalyst article described herein. The testing catalysts made according to this method show improved catalytic properties compared to conventional TWC (with the same or similar PGM loading) (e.g., see Examples 1-3; and Tables 2-4).

Another aspect of the present disclosure is directed to a system for treating vehicular exhaust gas from a CNG engine comprising the catalyst article described herein in conjunction with a conduit for transferring the exhaust gas through the system.

### Definitions

The term “region” as used herein refers to an area on a substrate, typically obtained by drying and/or calcining a washcoat. A “region” can, for example, be disposed or supported on a substrate as a “layer” or a “zone”. The area or arrangement on a substrate is generally controlled during the process of applying the washcoat to the substrate. The “region” typically has distinct boundaries or edges (i.e. it is possible to distinguish one region from another region using conventional analytical techniques).

Typically, the “region” has a substantially uniform length. The reference to a “substantially uniform length” in this context refers to a length that does not deviate (e.g. the difference between the maximum and minimum length) by more than 10%, preferably does not deviate by more than 5%, more preferably does not deviate by more than 1%, from its mean value.

It is preferable that each “region” has a substantially uniform composition (i.e. there is no substantial difference in the composition of the washcoat when comparing one part of the region with another part of that region). Substantially uniform composition in this context refers to a material (e.g. region) where the difference in composition when comparing one part of the region with another part of the region is 5% or less, usually 2.5% or less, and most commonly 1% or less.

The term “zone” as used herein refers to a region having a length that is less than the total length of the substrate, such as ≤75% of the total length of the substrate. A “zone” typically has a length (i.e. a substantially uniform length) of at least 5% (e.g. ≥5%) of the total length of the substrate.

The total length of a substrate is the distance between its inlet end and its outlet end (e.g. the opposing ends of the substrate).

Any reference to a “zone disposed at an inlet end of the substrate” used herein refers to a zone disposed or supported on a substrate where the zone is nearer to an inlet end of the substrate than the zone is to an outlet end of the substrate. Thus, the midpoint of the zone (i.e. at half its length) is nearer to the inlet end of the substrate than the midpoint is to the outlet end of the substrate. Similarly, any reference to a “zone disposed at an outlet end of the substrate” used herein refers to a zone disposed or supported on a substrate where the zone is nearer to an outlet end of the substrate than the zone is to an inlet end of the substrate. Thus, the midpoint of the zone (i.e. at half its length) is nearer to the outlet end of the substrate than the midpoint is to the inlet end of the substrate.

When the substrate is a wall-flow filter, then generally any reference to a “zone disposed at an inlet end of the substrate” refers to a zone disposed or supported on the substrate that is:
(a) nearer to an inlet end (e.g. open end) of an inlet channel of the substrate than the zone is to a closed end (e.g. blocked or plugged end) of the inlet channel, and/or
(b) nearer to a closed end (e.g. blocked or plugged end) of an outlet channel of the substrate than the zone is to an outlet end (e.g. open end) of the outlet channel.

Thus, the midpoint of the zone (i.e. at half its length) is (a) nearer to an inlet end of an inlet channel of the substrate than the midpoint is to the closed end of the inlet channel, and/or (b) nearer to a closed end of an outlet channel of the substrate than the midpoint is to an outlet end of the outlet channel.

Similarly, any reference to a “zone disposed at an outlet end of the substrate” when the substrate is a wall-flow filter refers to a zone disposed or supported on the substrate that is:
(a) nearer to an outlet end (e.g. an open end) of an outlet channel of the substrate than the zone is to a closed end (e.g. blocked or plugged) of the outlet channel, and/or
(b) nearer to a closed end (e.g. blocked or plugged end) of an inlet channel of the substrate than it is to an inlet end (e.g. an open end) of the inlet channel.

Thus, the midpoint of the zone (i.e. at half its length) is (a) nearer to an outlet end of an outlet channel of the substrate than the midpoint is to the closed end of the outlet channel, and/or (b) nearer to a closed end of an inlet channel of the substrate than the midpoint is to an inlet end of the inlet channel.

A zone may satisfy both (a) and (b) when the washcoat is present in the wall of the wall-flow filter (i.e. the zone is in-wall).

The term “washcoat” is well known in the art and refers to an adherent coating that is applied to a substrate usually during production of a catalyst.

The acronym “PGM” as used herein refers to “platinum group metal”. The term “platinum group metal” generally refers to a metal selected from the group consisting of Ru, Rh, Pd, Os, Ir and Pt, preferably a metal selected from the group consisting of Ru, Rh, Pd, Ir and Pt. In general, the term “PGM” preferably refers to a metal selected from the group consisting of Rh, Pt and Pd.

The term “mixed oxide” as used herein generally refers to a mixture of oxides in a single phase, as is conventionally known in the art. The term “composite oxide” as used herein generally refers to a composition of oxides having more than one phase, as is conventionally known in the art.

The expression “consist essentially” as used herein limits the scope of a feature to include the specified materials or steps, and any other materials or steps that do not materially affect the basic characteristics of that feature, such as for example minor impurities. The expression “consist essentially of” embraces the expression “consisting of”.

The expression “substantially free of” as used herein with reference to a material, typically in the context of the content of a region, a layer or a zone, means that the material in a minor amount, such as ≤5% by weight, preferably ≤2% by weight, more preferably ≤1% by weight. The expression “substantially free of” embraces the expression “does not comprise.”

The expression “essentially free of” as used herein with reference to a material, typically in the context of the content of a region, a layer or a zone, means that the material in a trace amount, such as ≤1% by weight, preferably ≤0.5% by weight, more preferably ≤0.1% by weight. The expression “essentially free of” embraces the expression “does not comprise.”

Any reference to an amount of dopant, particularly a total amount, expressed as a % by weight as used herein refers to the weight of the support material or the refractory metal oxide thereof.

The term “loading” as used herein refers to a measurement in units of g/ft³ on a metal weight basis.

The following examples merely illustrate the invention. Those skilled in the art will recognize many variations that are within the spirit of the invention and scope of the claims.

### EXAMPLES

### Materials

All materials are commercially available and were obtained from the known suppliers, unless noted otherwise.

### Catalyst 1 (Comparative)

Catalyst 1 is a typical Pt—Pd—Rh three-way with three catalytic regions in a double-layered structure as shown in FIG. 1a.

### First Catalytic Region:

The first catalytic region beginning at the inlet end which consists of Pt and Pd supported on a washcoat of a first CeZr mixed oxide, La-stabilized alumina, alkaline metal promotor. The washcoat loading of the first region was about 2.4 g/in³ with Pt loading of 11 g/ft³ and Pd loading of 23 g/ft³.

This washcoat was then coated from the inlet face of a ceramic substrate (400 cpsi, 4.3 mil wall thickness) using standard coating procedures with coating depth targeted of 50% of the substrate length, dried at 100° C.

### Second Catalytic Region:

The second catalytic region beginning at the outlet end which consists of Pt and Pd supported on a washcoat, the washcoat is the same as that used in the first catalytic region.

This washcoat was then coated from the outlet face of a ceramic substrate (400 cpsi, 4.3 mil wall thickness) using standard coating procedures with coating depth targeted of 50% of the substrate length, dried at 100° C. and calcined at 500° C. for 45 mins.

### Third Catalytic Region:

The third catalytic region consists of Rh supported on a washcoat of a second CeZr mixed oxide, La-stabilized alumina. The washcoat loading of the third region was about 1.3 g/in³ with a Rh loading of 4 g/ft³.

This washcoat was then coated from each end face of the ceramic substrate containing the first and the second catalytic region from above, using standard coating procedures with coating depth targeted of each dose is 50% of the substrate length, dried at 100° C. and calcined at 500° C. for 45 mins.

### Catalyst 2 (Comparative)

Catalyst 2 is a Pt—Pd—Rh three-way catalyst with three catalytic regions in a double-layered structure.

### First Catalytic Region:

The first catalytic region beginning at the inlet end which consists of Pd supported on a washcoat of a first CeZr mixed oxide, La-stabilized alumina, alkaline metal promotor. The washcoat loading of the first region was about 2.4 g/in³ with Pd loading of 34 g/ft³.

This washcoat was then coated from the inlet face of a ceramic substrate (400 cpsi, 4.3 mil wall thickness) using standard coating procedures with coating depth targeted of 67% of the substrate length, dried at 100° C.

### Second Catalytic Region:

The second catalytic region beginning at the outlet end which consists of Pt supported on a washcoat of a first CeZr mixed oxide, La-stabilized alumina, alkaline metal promotor. The washcoat loading of the first region was about 2.4 g/in³ with Pt loading of 34 g/ft³.

This washcoat was then coated from the outlet face of a ceramic substrate (400 cpsi, 4.3 mil wall thickness) using standard coating procedures with coating depth targeted of 33% of the substrate length, dried at 100° C. and calcined at 500° C. for 45 mins.

### Third Catalytic Region:

The third catalytic region consists of Rh supported on a washcoat of a second CeZr mixed oxide, La-stabilized alumina. The washcoat loading of the third region was about 1.3 g/in³ with a Rh loading of 4 g/ft³.

This washcoat was then coated from each end face of the ceramic substrate containing the first and the second catalytic region from above, using standard coating procedures with coating depth targeted of each dose is 50% of the substrate length, dried at 100° C. and calcined at 500° C. for 45 mins.

### Catalyst 3

Catalyst 3 is a Pt—Pd—Rh three-way catalyst with three catalytic regions in a double-layered structure.

### First Catalytic Region:

The first catalytic region beginning at the inlet end which consists of Pt supported on a washcoat of a first CeZr mixed oxide, La-stabilized alumina, alkaline metal promotor. The washcoat loading of the first region was about 2.4 g/in³ with Pt loading of 34 g/ft³.

This washcoat was then coated from the inlet face of a ceramic substrate (400 cpsi, 4.3 mil wall thickness) using standard coating procedures with coating depth targeted of 33% of the substrate length, dried at 100° C.

### Second Catalytic Region:

The second catalytic region beginning at the outlet end which consists of Pd supported on a washcoat of a first CeZr mixed oxide, La-stabilized alumina, alkaline metal promotor. The washcoat loading of the first region was about 2.4 g/in³ with Pd loading of 34 g/ft³.

This washcoat was then coated from the outlet face of a ceramic substrate (400 cpsi, 4.3 mil wall thickness) using standard coating procedures with coating depth targeted of 67% of the substrate length, dried at 100° C. and calcined at 500° C. for 45 mins.

### Third Catalytic Region:

The third catalytic region consists of Rh supported on a washcoat of a second CeZr mixed oxide, La-stabilized alumina. The washcoat loading of the third region was about 1.3 g/in³ with a Rh loading of 4 g/ft³.

This washcoat was then coated from each end face of the ceramic substrate containing the first and the second catalytic region from above, using standard coating procedures with coating depth targeted of each dose is 50% of the substrate length, dried at 100° C. and calcined at 500° C. for 45 mins.

### Catalyst 4 (Comparative)

Catalyst 4 is a Pd—Rh three-way catalyst with three catalytic regions in a double-layered structure.

### First Catalytic Region:

The first catalytic region beginning at the inlet end which consists of Pd supported on a washcoat of a first CeZr mixed oxide, La-stabilized alumina, alkaline metal promotor. The washcoat loading of the first region was about 2.4 g/in³ with Pd loading of 34 g/ft³.

This washcoat was then coated from the inlet face of a ceramic substrate (400 cpsi, 4.3 mil wall thickness) using standard coating procedures with coating depth targeted of 50% of the substrate length, dried at 100° C.

### Second Catalytic Region:

The second catalytic region beginning at the outlet end which consists of Pd supported on a washcoat, the washcoat is the same as that in the first catalytic region.

This washcoat was then coated from the outlet face of a ceramic substrate (400 cpsi, 4.3 mil wall thickness) using standard coating procedures with coating depth targeted of 50% of the substrate length, dried at 100° C. and calcined at 500° C. for 45 mins.

### Third Catalytic Region:

The third catalytic region consists of Rh supported on a washcoat of a second CeZr mixed oxide, La-stabilized alumina. The washcoat loading of the third region was about 1.3 g/in³ with a Rh loading of 4 g/ft³.

This washcoat was then coated from each end face of the ceramic substrate containing the first and the second catalytic region from above, using standard coating procedures with coating depth targeted of each dose is 50% of the substrate length, dried at 100° C. and calcined at 500° C. for 45 mins.

### Catalyst 5 (Comparative)

Catalyst 5 is a Pt—Rh three-way catalyst with three catalytic regions in a double-layered structure.

### First Catalytic Region:

The first catalytic region beginning at the inlet end which consists of Pt supported on a washcoat of a first CeZr mixed oxide, La-stabilized alumina, alkaline metal promotor. The washcoat loading of the first region was about 2.4 g/in³ with Pt loading of 34 g/ft³.

This washcoat was then coated from the inlet face of a ceramic substrate (400 cpsi, 4.3 mil wall thickness) using standard coating procedures with coating depth targeted of 50% of the substrate length, dried at 100° C.

### Second Catalytic Region:

The second catalytic region beginning at the outlet end which consists of Pt supported on a washcoat, the washcoat is the same as that in the first catalytic region.

This washcoat was then coated from the outlet face of a ceramic substrate (400 cpsi, 4.3 mil wall thickness) using standard coating procedures with coating depth targeted of 50% of the substrate length, dried at 100° C. and calcined at 500° C. for 45 mins.

### Third Catalytic Region:

The third catalytic region consists of Rh supported on a washcoat of a second CeZr mixed oxide, La-stabilized alumina. The washcoat loading of the third region was about 1.3 g/in³ with a Rh loading of 4 g/ft³.

This washcoat was then coated from each end face of the ceramic substrate containing the first and the second catalytic region from above, using standard coating procedures with coating depth targeted of each dose is 50% of the substrate length, dried at 100° C. and calcined at 500° C. for 45 mins.

### Catalyst 6 (Comparative)

Catalyst 6 is a Pt—Pd—Rh three-way catalyst with three catalytic regions in a double-layered structure.

### First Catalytic Region:

The first catalytic region beginning at the inlet end which consists of Pd supported on a washcoat of a first CeZr mixed oxide, La-stabilized alumina, alkaline metal promotor. The washcoat loading of the first region was about 2.4 g/in³ with Pd loading of 34 g/ft³.

This washcoat was then coated from the inlet face of a ceramic substrate (400 cpsi, 4.3 mil wall thickness) using standard coating procedures with coating depth targeted of 50% of the substrate length, dried at 100° C.

### Second Catalytic Region:

The second catalytic region beginning at the outlet end which consists of Pt supported on a washcoat of a first CeZr mixed oxide, La-stabilized alumina, alkaline metal promotor. The washcoat loading of the first region was about 2.4 g/in³ with Pt loading of 34 g/ft³.

This washcoat was then coated from the outlet face of a ceramic substrate (400 cpsi, 4.3 mil wall thickness) using standard coating procedures with coating depth targeted of 50% of the substrate length, dried at 100° C. and calcined at 500° C. for 45 mins.

### Third Catalytic Region:

The third catalytic region consists of Rh supported on a washcoat of a second CeZr mixed oxide, La-stabilized alumina. The washcoat loading of the third region was about 1.3 g/in³ with a Rh loading of 4 g/ft³.

This washcoat was then coated from each end face of the ceramic substrate containing the first and the second catalytic region from above, using standard coating procedures with coating depth targeted of each dose is 50% of the substrate length, dried at 100° C. and calcined at 500° C. for 45 mins.

### Catalyst 7

Catalyst 7 is a Pt—Pd—Rh three-way catalyst with three catalytic regions in a double-layered structure.

### First Catalytic Region:

The first catalytic region beginning at the inlet end which consists of Pt supported on a washcoat of a first CeZr mixed oxide, La-stabilized alumina, alkaline metal promotor. The washcoat loading of the first region was about 2.4 g/in³ with Pt loading of 34 g/ft³.

This washcoat was then coated from the inlet face of a ceramic substrate (400 cpsi, 4.3 mil wall thickness) using standard coating procedures with coating depth targeted of 50% of the substrate length, dried at 100° C.

### Second Catalytic Region:

The second catalytic region beginning at the outlet end which consists of Pd supported on a washcoat of a first CeZr mixed oxide, La-stabilized alumina, alkaline metal promotor. The washcoat loading of the first region was about 2.4 g/in³ with Pd loading of 34 g/ft³.

This washcoat was then coated from the outlet face of a ceramic substrate (400 cpsi, 4.3 mil wall thickness) using standard coating procedures with coating depth targeted of 50% of the substrate length, dried at 100° C. and calcined at 500° C. for 45 mins.

### Third Catalytic Region:

The third catalytic region consists of Rh supported on a washcoat of a second CeZr mixed oxide, La-stabilized alumina. The washcoat loading of the third region was about 1.3 g/in³ with a Rh loading of 4 g/ft³.

This washcoat was then coated from each end face of the ceramic substrate containing the first and the second catalytic region from above, using standard coating procedures with coating depth targeted of each dose is 50% of the substrate length, dried at 100° C. and calcined at 500° C. for 45 mins.

### Catalyst 8

Catalyst 8 is a Pt—Pd—Rh three-way catalyst with a double-layered structure in three catalytic regions, which is the same as Comparative Catalyst 1 except for PGM loading, Both the first and second catalytic region have the same Pt loading of 4 g/ft³ and the same Pd loading of 8 g/ft³, and Rh loading of 1 g/ft³ in the third region.

### Example 1: Light Off Performances Test in Synthetic Catalyst Activity Testing

Catalyst performance testing were performed on Comparative Catalyst 1, Comparative Catalyst 2, and Catalyst 3 under the following conditions using a simulated exhaust gas with perturbation having the composition shown in Table 1.

TABLE 1
Simulated Gas Composition for the Performance Test

| | H₂ | CO | NO | O₂ | CH₄ | C₂H₆ | CO₂ | H₂O |
|---|---|---|---|---|---|---|---|---|
| Cycle | [ppm] | [%] | [ppm] | [%] | [ppm] | [ppm] | [%] | [%] |
| −3% | 3000 | 1 | 1000 | 0.68 | 3000 | 120 | 5 | 10 |
| Mean | 3000 | 1 | 1000 | 1.18 | 3000 | 120 | 5 | 10 |
| +3% | 3000 | 1 | 1000 | 1.68 | 3000 | 120 | 5 | 10 |

In the catalyst performance testing, the gas flow rate was set at a spatial velocity of 40,000/hr, the temperature was ramp up from 100° C. to 550° C. with the heating rate of 10° C./min, and the gas composition was analyzed after passing through the catalyst. The lower T₅₀ (the temperatures at conversion of 50%) means the better catalytic performance. Comparative Catalyst 1, Comparative Catalyst 2, and Catalyst 3 were oven aged for 36 hours at 850° C. with 10% H₂O in air.

As shown in Table 2, the temperatures at conversion of 50% for CH₄ and NOₓ, were significantly lower for Catalyst 3, compared with that of Comparative Catalyst 1 and 2.

TABLE 2
SCAT CH₄ and NOₓ Light off testing results

T₅₀ (° C.)

| | CH₄ | NOₓ |
|---|---|---|
| Comparative Catalyst 1 | 487 | 478 |
| Comparative Catalyst 2 | 428 | 414 |
| Catalyst 3 | 406 | 266 |

### Example 2—CNG Vehicle Testing Procedures and Results

Comparative Catalyst 1, Comparative Catalyst 2, and Catalyst 3 were also tested by a light duty CNG vehicle equipped with 1.6 L engine under world light vehicle test cycle (WLTC) to evaluate the emission control ability. The catalysts were aged under the conditions of SBC860 for 73 hrs on gasoline engine bench.

From the results of emissions by a CNG vehicle as shown in Table 3, Catalyst 3 showed comparable CH₄ emission with Comparative Catalyst 2 and much lower NOₓ emission as compared with Comparative Catalyst 1 and 2.

TABLE 3
Results of Emissions by CNG Vehicle Diluted Bag Data

| | Exhaust Emissions (mg/km) | | |
|---|---|---|---|
| | CH₄ | CO/10 | NOₓ |
| Comparative Catalyst 1 | 163.5 | 20.7 | 180.4 |
| Comparative Catalyst 2 | 136.5 | 23.3 | 153.1 |
| Catalyst 3 | 134.4 | 25.6 | 83.5 |

### Example 3—CNG Bench Testing Procedures and Results

Catalyst performance testing was carried out by natural gas engine under world harmonized transient cycle (WHTC). The WHTC test was considered as a reliable way of emission evaluation for engine operation. Cold and hot state WHTC test was conducted for each catalyst and emissions were measured post-catalyst. The final WHTC emission value is the sum of cold state and hot state WHTC, which account for 14% and 86% respectively.

In WHTC test, the aftertreatment system consists of two bricks with the layout of Comparative catalyst 4, 5, 6, or Catalyst 7 at upstream, and Catalyst 8 at downstream. The following Systems were tested for their catalytic performances
System 1: Comparative Catalyst 4+Catalyst 8
System 2: Comparative Catalyst 5+Catalyst 8
System 3: Comparative Catalyst 6+Catalyst 8
System 4: Catalyst 7+Catalyst 8

The parts were oven aged under the conditions of 850° C. for 36 hrs with 10% H₂O in air. Emission results on natural gas engine toward System 1 to 3 were shown in Table 4. The results exhibited that System 4 shows the lowest NOₓ emission at 275 mg/kwh, when Catalyst 7 was replaced by any one of Comparative Catalysts 4-6, NOₓ emission increased significantly. CO and CH₄ emissions from all the systems 1-3 have much margin within China VI legislation limit.

TABLE 4
Emission results on natural gas engine under WHTC cycle

| | | Emissions on natural | | |
|---|---|---|---|---|
| | Catalyst Article | gas engine (mg/kwh) | | |
| System | Arrangement | CO | CH₄ | NOₓ |
| System 1 | Comparative Catalyst 4 + | 530 | 304 | 313 |
| | Catalyst 8 | | | |
| System 2 | Comparative Catalyst 5 + | 780 | 501 | 305 |
| | Catalyst 8 | | | |
| System 3 | Comparative Catalyst 6 + | 550 | 342 | 330 |
| | Catalyst 8 | | | |
| System 4 | Catalyst 7 + Catalyst 8 | 680 | 363 | 275 |

| | | | |
|---|---|---|---|
| China VI legislation limit | 4000 | 500 | 460 |

We claim:

1. A catalyst article for treating exhaust gas from compressed natural gas (CNG) engine comprising:
a substrate comprising an inlet end, an outlet end with an axial length L;
a first catalytic region beginning at the inlet end and extending for less than the axial length L, wherein the first catalytic region comprises a first platinum component;
a second catalytic region beginning at the outlet end and extending for less than the axial length L, wherein the second catalytic region comprises a second palladium component; and
a third catalytic region, wherein the third catalytic region comprises a third rhodium component.

2. The catalyst article of claim 1, wherein the first catalytic region extends for 10 to 90 percent of the axial length L.

3. The catalyst article of claim 1, wherein the second catalytic region extends for 10 to 90 percent of the axial length L.

4. The catalyst article of claim 1, wherein the second catalytic region overlaps with the first catalytic region for 1 to 80 percent of the axial length L.

5. The catalyst article of claim 1, wherein the total length of the second catalytic region and the first catalytic region equals to the axial length L.

6. The catalyst article of claim 1, wherein the total length of the second catalytic region and the first catalytic region is less than the axial length L.

7. The catalyst article of claim 1, wherein the third catalytic region extends for 100 percent of the axial length L.

8. The catalyst article of claim 1, wherein the third catalytic region extends for less than 100 percent of the axial length L.

9. The catalyst article of claim 1, wherein the first catalytic region further comprises a first OSC material, a first alkali or alkaline earth metal component, a first inorganic oxide, and/or a first rare earth component

10. The catalyst article of claim 1, wherein the second catalytic region further comprises a second platinum component, a second OSC material, a second alkali or alkaline earth metal component, a second inorganic oxide, and/or a second rare earth component.

11. The catalyst article of claim 1, wherein the third catalytic region further comprises a third platinum group metal (PGM) component, a third OSC material, a third alkali or alkaline earth metal component, and/or a third inorganic oxide.

12. The catalyst article of claim 11, wherein the third PGM component is Pd, Pt, or a combination thereof.

13. The catalyst article of claim 1, wherein the first Pt component in the first catalytic region is at least 50% of the overall Pt loading in the catalyst article.

14. The catalyst article of claim 1, wherein the substrate is a flow-through monolith.

15. The catalyst article of claim 1, wherein the first catalytic region is supported/deposited directly on the substrate.

16. The catalyst article of claim 1, wherein the second catalytic region is supported/deposited directly on the substrate.

17. The catalyst article of claim 1, wherein the third catalytic region is supported/deposited directly on the substrate.

18. An emission treatment system for treating a flow of a CNG exhaust gas comprising the catalyst article of claim 1.

19. A method of treating an exhaust gas from a CNG engine comprising contacting the exhaust gas with the catalyst article of claim 1.
